(19) United States
(12) Patent Application Publication
(10) Pub. No.: US 2010/0298470 A1
(43) Pub. Date: Nov. 25, 2010

(54) PROCESS FOR CONTINUOUSLY PREPARING AN ORGANOPHOSPHORUS COMPOUND AND USE THEREOF

(76) Inventors: Andreas Kaplan, Chur (CH); René Gisler, Chur (CH); Christopher Kohl, Bonaduz (CH)

Correspondence Address: BARNES & THORNBURG LLP, 11 SOUTH MERIDIAN, INDIANAPOLIS, IN, 46204, US

(21) Appl. No.: 12/738,715

(22) PCT Filed: Oct. 16, 2008
(86) PCT No.: PCT/EP08/08782

§ 371 Date: Jul. 29, 2010

(30) Foreign Application Priority Data
Oct. 26, 2007 (EP) 07021015.8

(51) Int. Cl. C08K 5/53; C07F 9/6574

(52) U.S. Cl. 523/451; 558/73

(57) ABSTRACT

The present invention relates to the production of organophosphorus compounds, in particular 9,10-dihydro-9-oxa-10-phosphaphenanthrene-10-oxide (DOPO) or derivatives thereof which have been known for many years in prior art. They are used preferably as additives for polymers. In particular the use of DOPO and derivatives thereof as flame retardants for polymers, such as e.g. polyesters, polyamides, epoxy resins, has proved to be advantageous.

Organophosphorus compounds, in particular 9,10-dihydro-9-oxa-10-phosphaphenanthrene-10-oxide (DOPO) or derivatives thereof have been known for many years in prior art and are used preferably as additives for polymers. In particular the use of DOPO and derivatives thereof as flame retardants for polymers, such as e.g. polyesters, polyamides, epoxy resins, has proved to be advantageous.

Thus JP 5017979 describes a method for the production of DOPO and the use thereof as additive in polymers. Furthermore, a method for the production of DOPO and the use thereof as flame retardant is known from JP 59-222496 from 1984.

Because of the increasing importance of DOPO or its derivatives as additive, in particular as halogen-free flame retardant for polymers, great interest exists in a technically simple, economic and reliable production method for DOPO and derivatives thereof. Phosphorus-containing by-products, such as phosphorous acid, phosphines, also termed phosphanes, and white phosphorus present difficulties in production of DOPO. These impurities occurring in the production of DOPO and derivatives thereof require complex cleaning of the plants and represent a risk to the operating and cleaning personnel.

In prior art, discontinuous production methods, so-called batch production methods, have been known to date for DOPO. Such a batch method is described for example in JP 5017979.

Starting herefrom, it is now the object of the present invention to indicate a new continuous production method of DOPO and derivatives thereof. The continuous production method is intended to enable a simple and reliable mode of operation and to provide products of constant quality, high purity and with a high yield.

This object is achieved by the characterising features of patent claim 1. The sub-claims reveal advantageous developments.

The method according to the invention is hence distinguished in that at least the following steps are undergone:
Step 1 esterification of the o-phenylphenol of the general formula IV with an excess of PX₃ of the general formula (III) in the presence of one or more catalysts,
Step 2 cyclisation of the product from step 1 with a catalyst, and
Step 3 hydrolysis of the product from step 2.

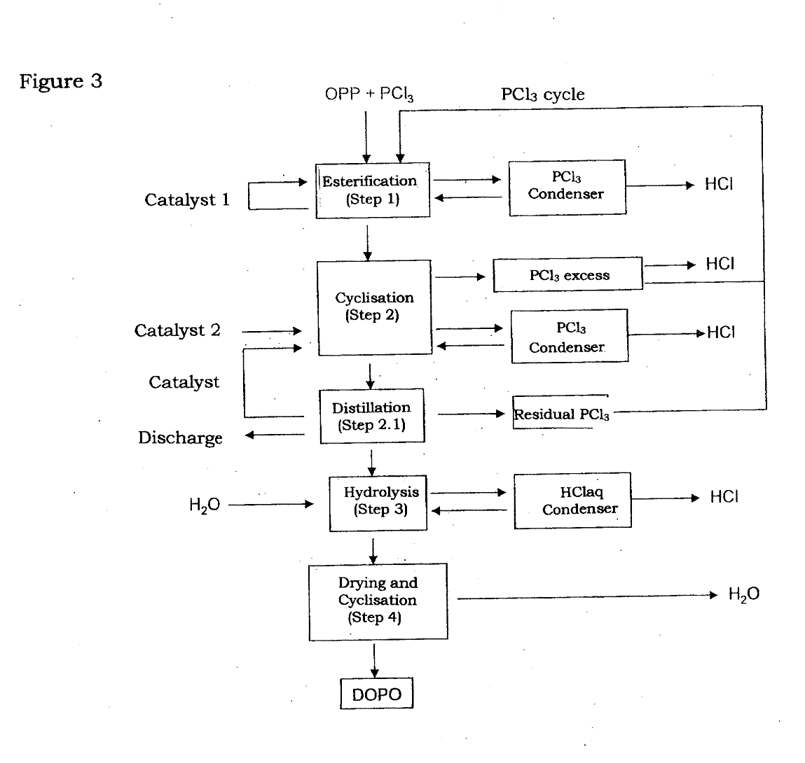

In the method according to the invention, the following steps are implemented preferably in a continuous process in succession under protective gas (in this respect see FIG. 3):
Step 1: esterification of the ortho-phenylphenol (o-phenylphenol) of the general formula (IV),

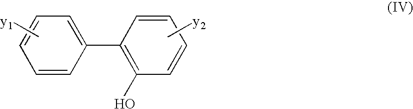

wherein y₁ and y₂, which can be the same or different, can be hydrogen- or halogen atoms, alkyl groups with C₁ to C₁₈, alkoxy groups with C₁ to C₁₈, aryl groups, aryloxy groups, acyl groups, nitro groups or cyano groups, the radicals y₁ and y₂ being able also to form together with the biphenyl ring a phenanthrene ring,
in the presence of one or more catalysts with an excess of phosphorus trihalogenide of the general formula (III)

PX₃ (III)
wherein X stands for a halogen,
Step 2: cyclisation of the intermediate product from step 1 in the presence of a catalyst and recirculation of the non-reacted phosphorus trihalogenide,
Step 2.1: distillation of the intermediate product from step 2, the residue being recirculated into step 2,
Step 3: hydrolysis of the distillate from step 2 to form the intermediate product of the general formula (II)

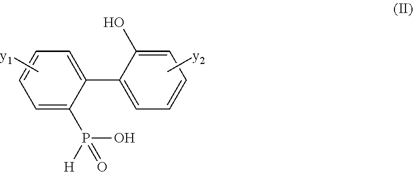

wherein the radicals y₁ and y₂ have the above-mentioned meaning,
Step 3.1: discharge of the intermediate product of the general formula (II) in the form of flakes, and
Step 4: drying and cyclisation of the intermediate product (II) to form the end product of the general formula (I)

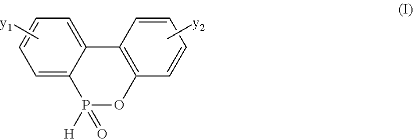

A detailed description of the individual steps of the preferred embodiment are indicated subsequently.

### Step 1:

The conversion takes place at the temperature of the PX₃ boiling at reflux under atmospheric pressure in the presence of one or more catalysts.

In the method according to the invention, it has emerged as particularly advantageous if the process takes place in step 1 with an excess of PX₃. The excess of phosphorus trihalogenide can thereby be in the range of 1.1 to 5 mol PX₃, preferably 1.1 to 3 mol PX₃, relative to 1 mol of the o-phenylphenol of the general formula (IV). The excess of phosphorus trihalogenide (general formula III) is important in order to displace the equilibrium of the esterification reaction towards the monoester.

In the method according to the invention, there is used preferably as phosphorus trihalogenide, phosphorus trichloride (PCl₃) or phosphorus tribromide (PBr₃), phosphorus trichloride (PCl₃) is particularly preferred. The reaction temperature is preferably at 25 to 180° C., particularly preferred at 25 to 85° C.

According to the catalyst used, ionic liquids or ion exchangers, the thereby used temperatures are different.

The catalyst is normally used in a quantity of 0.01 to 0.06 mol, preferably 0.02 to 0.04 mol, relative to 1 mol of the o-phenylphenol or 3-60% by weight, preferably 10-40% by weight, particularly preferred 15 to 20% by weight, relative to o-phenylphenol. Ionic liquids or ion exchangers can be used as catalyst. These display high selectivity, lead to great shortening of the reaction time and can be separated easily at the end of the 1^{st} step. The separated catalyst remains in step 1 or is recirculated into step 1.

These catalysts effect an improved yield of monoester which has in addition also increased purity.

Ionic liquids are compounds exclusively comprising ions (cations and anions). The melting points of these compounds are preferably at 0-90° C., particularly preferred at 30-85° C. The cations concern positively-charged quaternary nitrogen- or phosphorus compounds. The anions concern halogen- or sulphur-containing negatively-charged particles of an atomic or molecular order of magnitude, e.g. metal complexes. Examples of cations are dialkylimidazolium, alkylpyridinium, tetraalkylammonium or tetraalkylphosphonium. Examples of anions are chloride, bromide, tetrafluoroborate, tetrachloroaluminate, tetrachloroferrate (III), hexafluorophosphate, hexafluoroantimonate, trifluoromethanesulphate, alkylsulphonate, benzenesulphonate or bis(trifluoromethylsulphonyl)imide, chloride being preferred.

Preferred ionic liquids are 1-butyl-3-methylimidazolium chloride (melting point approx. 70° C.), 1-decyl-3-methylimidazolium chloride (liquid at 20° C.), 1-ethyl-3-methylimidazolium chloride (melting point 77-79° C.), 1-methylimidazolium chloride (melting point approx. 75° C.), 1-methyl-3-octylimidazolium chloride (liquid at 20° C.), benzyldimethyltetradecylammonium chloride (melting point 56-62° C.), tetradodecylammonium chloride (liquid at 20° C.), tetraheptylammonium chloride (melting point 38-40° C.) or 2-ethylpyridinium chloride (melting point approx. 55° C.).

The ion exchangers can be used in the form of solid particles, solid membranes, papers or layers. Of concern are anion exchangers or chelate resins, the matrix of which consists of for example phenolformaldehyde condensates, copolymers of styrene and divinylbenzene, colpolymers of methacrylates and divinylbenzene, cellulose, crosslinked dextrane or crosslinked agarose. The functional groups fixed on the matrix are e.g. diethylaminoethyl, quaternary (fourfold) aminomethyl, triethylaminoethyl, polyetheleneimine, triethylaminopropyl or chelate-forming groups which contain oxygen-, nitrogen- or sulphur donor atoms.

There are used as counterions in the case of anion exchangers preferably halogenide ions, particularly preferred chloride ions.

There are used preferably ion exchangers of type I which are macroporous and highly basic, have halogenide ions as counterion and in the case of which the carrier is a copolymer of styrene and divinylbenzene. Chloride is used particularly preferably as halogenide ion.

Examples of preferred ion exchangers (type I, macroporous, highly basic, chloride form) are Lewatit MonoPlus MP 500, Dowex Marathon MSA, Dowex Upcore Mono-MA600, Dowex MSA-1C, Amberlite IRA 900RFCl or Amberlite IRA 910UCl.

An advantage of the ion exchangers as catalysts resides in the fact that these catalysts can be used as solid bed catalysts, as a result of which separation is unnecessary.

Ion exchangers, in particular anion exchangers or chelate resins, are used preferably as catalysts as opposed to ionic liquids.

When using ionic liquids or ion exchangers as catalyst, the cyclisation can be constructed to be smaller and hence more economical since the monoester (e.g. DOPCl) after the 1^{st} step has fewer by-products (e.g. diester, triester, o-phenylphenol). The previously mentioned by-products need not therefore be converted over a fairly long reaction time in the cyclisation step into DOPCl, which takes place only incompletely and therefore also unsatisfactorily.

The esterification (step 1) is implemented preferably in reactors or reactor cascades with as low as possible back-mixing.

The reactors or reactor cascades preferably manage without moveable parts.

### Step 2:

The cyclisation in step 2 is implemented, in the method according to the invention, preferably at atmospheric pressure and at a temperature >140° C., preferably 140 to 200° C., particularly preferred 140 to 180° C., very particularly preferred 140 to 155° C. At a cyclisation temperature of 140-155° C., a particularly pure, colourless, water-white product is produced. The PX₃ boiling off at the beginning of the cyclisation because of the reaction temperature is only condensed as long as 5-30% by weight, preferably 10-20% by weight of PX₃, still remains in the reaction mixture. The condensed PX₃ is recirculated into step 1. As a result of this content of PX₃ during the cyclisation, the yield of DOP-X is increased and the purity thereof is improved.

The catalyst for the cyclisation (step 2) is added at the beginning of step 2 and past dosed during the cyclisation at least so often that it is always present in a quantity of at least 0.01 mol, preferably at least 0.02 mol, relative to 1 mol of the o-phenylphenol.

The quantity of catalyst to be used is determined by means of the quantity of o-phenylphenol used. Normally the catalyst is used in a quantity of 0.01 to 0.06 mol, preferably 0.02 to 0.04 mol, relative to 1 mol of the o-phenylphenol. There can be used as catalyst in the method according to the invention basically all metals of the group I B of the periodic table and the halogenides thereof, metals of group II B and the halogenides thereof, metals of group III A and the halogenides thereof, metals of group III B and the halogenides thereof, metals of group IV A and the halogenides thereof, metals of group IV B and the halogenides thereof and also the metals of the iron group and the halogenides thereof. Specific examples are copper, copper(I)chloride, copper(II)chloride, zinc, zinc chloride, cadmium chloride, aluminium, aluminium chloride, scandium chloride, tin, tin(II)chloride, tin(IV)chloride, zirconium chloride, chromium chloride and iron(III)chloride.

Zinc chloride (ZnCl₂) is preferred as catalyst in the method according to the invention. It is used preferably as a dispersion in PX₃. Zinc chloride itself displays a catalytic effect. In the reaction mixture, a catalytically even more active species is formed at temperatures above 140° C. The zinc chloride thereby dissolves in the reaction mixture.

### Step 2.1:

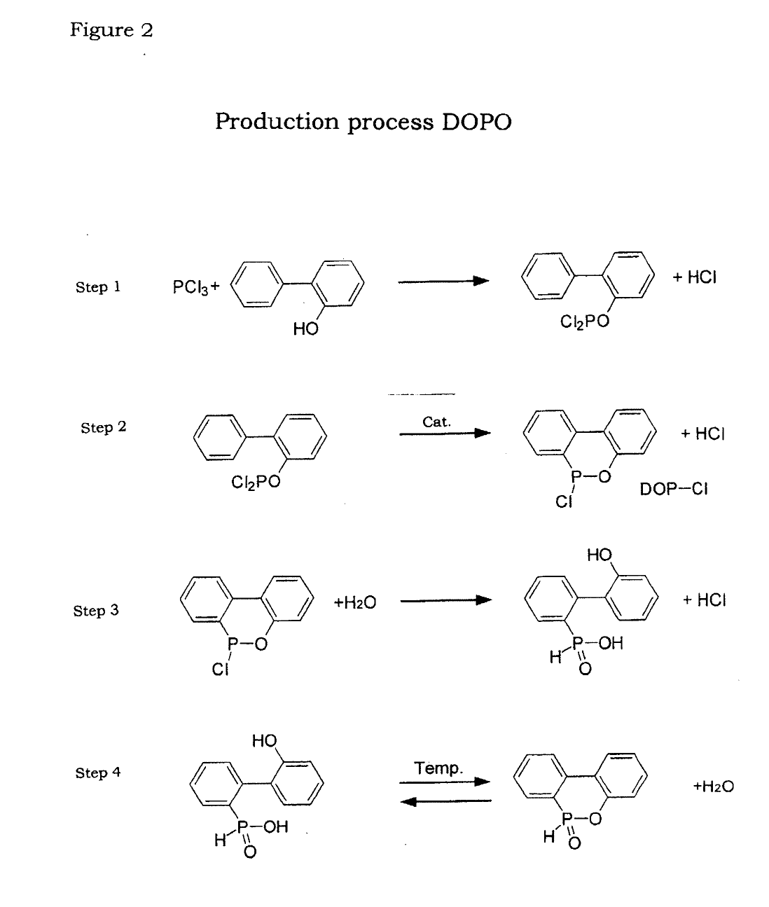

During the vacuum distillation subsequent to the cyclisation, the cyclised intermediate product DOP-X (e.g. DOP-Cl, FIG. 2) is separated as distillate. The DOP-X here has a purity of at least 90% by weight. The vacuum distillation is effected at a temperature of 130 to 180° C., preferably 140 to 170° C., particularly preferred 140 to 160° C. and at a pressure of 0.5 to 20 mbar, preferably 1 to 10 mbar, particularly preferred 1 to 5 mbar.

Particularly suitable for this purpose are e.g. thin-film evaporators and short-path distillation plants since they enable particularly gentle distillation.

The residue of the distillation contains the catalyst, inter alia in the form of catalytically active species, e.g. adducts, diesters and traces of triesters, non-reacted OPP and by-products.

This residue, inclusive of the catalyst or of the catalytically active species, is recirculated into step 2, its temperature not being allowed to drop below 80° C., preferably not below 100° C., particularly preferred not below 140° C.

If required, a part of the residue can also be discharged, the loss of catalyst or of catalytically active species being able to be replaced with zinc chloride.

### Step 3:

The hydrolysis of the distillate (DOP-X) from step 2.1 with water is implemented at atmospheric pressure and at temperatures of 80 to 100° C., preferably 90 to 100° C., very particularly preferred in boiling water. The amount of water hereby used is such that a two-phase mixture can be formed. The lower phase is thereby the molten product in the open form of the general formula (II) and the upper aqueous phase contains the separated HX.

### Step 3.1:

The discharge of the product melt is effected by means of a melt pump through a slot nozzle onto an endless belt, said melt solidifying to form irregular plates which are then broken up to form flakes. This step also is implemented in a closed system under a protective gas atmosphere.

### Step 4:

The flakes are predried on a belt dryer at 80 to 105° C., preferably 90 to 100° C. and, in a vacuum at 20 to 100 mbar, preferably 30 to 50 mbar and 90 to 100° C., are cyclised and dried to form the end product of the general formula (I).

The ring closure to form the end product of the general formula (I) can also be effected subsequent to step 4 on the molten product in the open form of the general formula (II).

In an alternative embodiment of the method according to the invention, the hydrolysis (step 3a) of the distillate (DOP-X) from step 2.1 is implemented at a molar ratio DOP-X:water of 1:1 to 1:2, preferably 1:1 to 1:1.5, very preferably 1:1 to 1:1.3, particularly preferred 1:1 to 1:1.1. The hydrolysis is implemented very particularly preferably at a molar ratio DOP-X:water of 1:1. With an equimolar ratio, the HX is split to form a gas and discharged with the waste air. Even during cyclisation, the closed form (formula I) of the end product is formed. This makes the reaction step of conversion of the open form by water separation into the closed form superfluous.

The hydrolysis can thereby be implemented with or without an additional inert, aromatic solvent.

If the process takes place without additional inert, aromatic solvent, the hydrolysis is effected at a pressure of 3 to 10 bar, preferably 5-8 bar, particularly preferred 5-7 bar. The temperature is 130-180° C., preferably 140-150° C. The end product is thereby present as a melt.

### Step 3.1a):

The discharge of the product melt is effected by means of a melt pump through a slot nozzle onto an endless belt, said product melt solidifying to form irregular plates which are then broken up to form flakes. Also this step is implemented in a closed system under a protective gas atmosphere.

### Step 4a:

The flakes are dried to form the end product on a belt drier at 80 to 105° C., preferably 90 to 100° C. (predried and in a vacuum at 20 to 100 mbar, preferably 30 to 50 mbar and 90 to 100° C.).

When using an additional inert, aromatic solvent during the hydrolysis (step 3a)), the hydrolysis is effected at normal pressure at temperatures of 70 to 240° C., preferably of 110 to 180° C. The end product occurring in the closed form (general formula (I)) crystallises out of the solution, is filtered off and dried as described in step 4a).

There can be used as inert, aromatic solvent, for example benzene, toluene, 1,2-xylene, 1,3-xylene, 1,4-xylene, hemimellitene, pseudocumene, mesitylene, isodurene, 1,2,3,4,-tetramethylbenzene, cumene, o-cumene, m-cymene, p-cymene, ethylbenzene, n-propylbenzene, n-butylbenzene, isobutylbenzene, sec.-butylbenzene, ter.-butylbenzene or mixtures thereof. There are used preferably toluene, 1,2-xylene, 1,3-xylene, 1,4-xylene, pseudocumene, mesitylene, isodurene, cumene, p-cymene, ethylbenzene, n-propylbenzene, n-butylbenzene, isobutylbenzene, sec.-butylbenzene, ter.-butylbenzene or mixtures thereof. There are used particularly preferably toluene, 1,2-xylene, 1,3-xylene, 1,4-xylene, mesitylene, p-cymene, ethylbenzene, n-propylbenzene, n-butylbenzene or mixtures thereof.

The hydrolysis is preferably implemented without additional inert, aromatic solvent.

The process takes place very particularly preferably during the hydrolysis with an equimolar ratio (1:1) DOP-X:water and without additional inert, aromatic solvent.

The water content of the end product is at most 0.2% by weight, preferably at most 0.1% by weight.

The purity of the end product is at least 90% by weight, preferably at least 95% by weight, particularly preferred at least 99% by weight, very particularly preferred at least 99.5% by weight.

The halogen content of the end product is at most 100 ppm, preferably at most 50 ppm, particularly preferred at most 30 ppm, very particularly preferred at most 25 ppm.

The content of ortho-phenylphenol is at most 0.5% by weight, preferably at most 0.3% by weight, particularly preferred at most 0.1% by weight.

In general, the end product of the continuous method according to the invention is so clean that further cleaning steps can be dispensed with.

Should, in exceptional cases, indeed additional cleaning be necessary this can be effected by recrystallisation, rectification and/or multiple distillation.

The HX produced in steps 1 to 3, as known from the state of the art, is collected for example in a gas washing or neutralised also with sodium hydroxide. The collection in a gas washing thereby has the advantage that the resulting acid solution can be reused for other purposes.

Buffer containers can be installed between the individual steps of the production method according to the invention in order to store in the interim the intermediate products of the individual method steps until introduction into the following step under protective gas.

The continuous production method according to the invention, relative to the discontinuous batch method at the same capacity of plant, has the advantage that smaller quantities of material are situated in the plant because of the continuous operation and hence smaller mass flows require to be managed. As a result, disturbances can be reacted to more rapidly and also the risk during “running away” of the reaction is minimised.

In addition, stationary conditions prevail in the individual steps.

Of course, the process can also take place in the batch method with recirculation of the catalyst and of the excess PX₃.

Steps 1 to 2.1 are extremely sensitive to the introduction of moisture, air humidity already being sufficient. If water is present in the system, the result is the formation of phosphorous acid by means of hydrolysis of the phosphorus trichloride, which phosphorous acid in the end leads to the formation and concentration of white phosphorus in the plant.

The continuous production method according to the invention concerns a closed system which is consequently protected very well against penetration of moisture. Only with the first start-up of the plant must the inertisation be taken into account particularly during metering of the educts and of the catalyst. During the batch method, this is however required again with each batch.

In the case of the continuous method according to the invention, a smaller cyclisation is required than with the batch method with the same capacity or with a continuous method with the same capacity without the catalysts according to the invention for step 1.

Continuous methods, relative to batch methods, have in addition advantages in the costs for production, energy and personnel.

The method according to the invention, as described above, has proved its worth in particular for the production of DOPO, i.e. an organic phosphorus compound of the general formula I in which y₁ and y₂ is hydrogen.

Furthermore the invention relates to an organophosphorus compound of the general formula I wherein the radicals indicated in formula I have the above-indicated meaning which can be produced by a method, as described above.

The organophosphorus compound of general formula I is suitable in particular as flame retardant, in particular for epoxy resins and the special application case of the semiconductor industry.

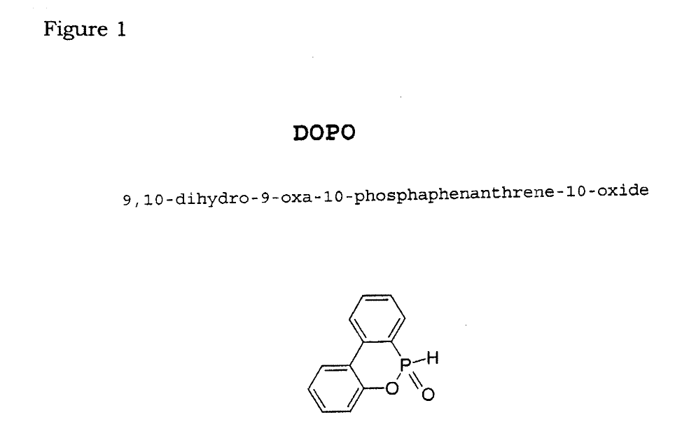

The invention is described subsequently in more detail with reference to FIGS. 1 to 3.

FIG. 1 shows the chemical structural formula and also the exact chemical name of the organic phosphorus compound according to the invention in the case where y₁ and y₂ is hydrogen. This compound has become known in the state of the art as DOPO.

FIG. 2 shows the chemical course of steps 1 to 4 with reference to the example DOPO.

FIG. 3 shows schematically the continuous production method of DOPO according to the invention.

The invention is now explained in addition in more detail with reference to the subsequent examples without restricting the invention to the parameters and materials used in particular.

### 1st Step (Esterification)

The ion-exchanger resins used for the esterification were dried before the start of the reaction in a circulating air oven at 110° C. until constancy of weight.

### EXAMPLE 1

### Comparative Example

0.75 g (5.5 mmol) water-free zinc chloride and 103 g (0.75 mol) phosphorus trichloride were weighed and added in succession to 25.5 g (0.15 mol) o-phenylphenol in a sulphonation flask with agitator, thermometer and bulb condenser under a nitrogen atmosphere and heated with agitation to 70° C. The HCl gas formed during the esterification was conducted over the top with the help of a continuous nitrogen flow into a neutralising solution. The course of the reaction was monitored by gas chromatography and by back titration or gravimetric analysis of the neutralising solution. The reaction was ended after 150 minutes and the HCl evolution ceased. The reaction mixture was filtered via a glass frit of pore size 3 and analysed (see Table 1).

### EXAMPLE 2

10% by weight Lewatit MonoPlus M 500 relative to o-phenylphenol and 103 g (0.75 mol) phosphorus trichloride were weighed and added in succession to 25.5 g (0.15 mol) o-phenylphenol in a sulphonation flask with agitator, thermometer and bulb condenser under a nitrogen atmosphere and heated with agitation to 70° C. The HCl gas formed during the esterification was conducted over the top with the help of a continuous nitrogen flow into a neutralising solution. The course of the reaction was monitored by gas chromatography and by back titration or gravimetric analysis of the neutralising solution. The reaction was ended after 90 minutes and the HCl evolution ceased. The reaction mixture was filtered via a glass frit of pore size 3 and analysed (see Table 1).

### EXAMPLE 3

5% by weight Amberlite IRA-900 Cl relative to o-phenylphenol and 61.8 g (0.45 mol) phosphorus trichloride were weighed and added in succession to 25.5 g (0.15 mol) o-phenylphenol in a sulphonation flask with agitator, thermometer and bulb condenser under a nitrogen atmosphere and heated with agitation to 65° C. The HCl gas formed during the esterification was conducted over the top with the help of a continuous nitrogen flow into a neutralising solution. The course of the reaction was monitored by gas chromatography and by back titration or gravimetric analysis of the neutralising solution. The reaction was ended after 60 minutes and the HCl evolution ceased. The reaction mixture was filtered via a glass frit of pore size 3 and analysed (see Table 1).

### EXAMPLE 4

20% by weight Amberlite IRA-900 Cl relative to o-phenylphenol and 61.8 g (0.45 mol) phosphorus trichloride were weighed and added in succession to 25.5 g (0.15 mol) o-phenylphenol in a sulphonation flask with agitator, thermometer and bulb condenser under a nitrogen atmosphere and heated with agitation to 65° C. The HCl gas formed during the esterification was conducted over the top with the help of a continuous nitrogen flow into a neutralising solution. The course of the reaction was monitored by gas chromatography and by back titration or gravimetric analysis of the neutralising solution. The reaction was ended after 35 minutes and the HCl evolution ceased. The reaction mixture was filtered via a glass frit of pore size 3 and analysed (see Table 1).

### EXAMPLE 5

20% by weight Amberlite IRA-900 Cl relative to o-phenylphenol and 61.8 g (0.45 mol) phosphorus trichloride were weighed and added in succession to 25.5 g (0.15 mol) o-phenylphenol in a sulphonation flask with agitator, thermometer and bulb condenser under a nitrogen atmosphere and heated with agitation to 40° C. The HCl gas formed during the esterification was conducted over the top with the help of a continuous nitrogen flow into a neutralising solution. The course of the reaction was monitored by gas chromatography and by back titration or gravimetric analysis of the neutralising solution. The reaction was ended after 100 minutes and the HCl evolution ceased. The reaction mixture was filtered via a glass frit of pore size 3 and analysed (see Table 1).

### EXAMPLE 6

61.8 g (0.45 mol) phosphorus trichloride and 2.6 g (0.015 mol) BASIONIC ST70 were weighed and added in succession to 25.5 g (0.15 mol) o-phenylphenol in a sulphonation flask with agitator, thermometer and bulb condenser under a nitrogen atmosphere and heated with agitation to 70° C. The HCl gas formed during the esterification was conducted over the top with the help of a continuous nitrogen flow into a neutralising solution. The course of the reaction was monitored by gas chromatography and by back titration or gravimetric analysis of the neutralising solution. The reaction was ended after 60 minutes and the HCl evolution ceased. The reaction mixture was two-phase, the lower phase (product phase) being separated from the catalyst with the help of a separating funnel and analysed (see Table 1).

TABLE 1

| | | | Reaction |
|---|---|---|---|
| Example | Ratio ME/DE | Ratio ME/TE | time/minutes |
| 1 | 5:1 | 14:1 | 150 |
| 2 | 10:1 | no triester | 90 |
| | | formation | |
| 3 | 13:1 | no triester | 60 |
| | | formation | |
| 4 | 12:1 | no triester | 35 |
| | | formation | |
| 5 | 13:1 | no triester | 100 |
| | | formation | |
| 6 | 16:1 | no triester | 60 |
| | | formation | |

ME = monoester, DE = diester, TE = triester

### EXAMPLE 7

20 g esterification product were placed in a heatable reaction column with a diameter of approx. 4 cm and a length of approx. 40 cm before 20.5 g Amberlite IRA-900 Cl were introduced with a further 60 g esterification product. The esterification product used here was produced analogously to example 4. Subsequently, the reaction column was temperature-controlled at 65° C. under a nitrogen atmosphere and metering with a mixture of phosphorus trichloride and o-phenylphenol in the molar ratio 3:1 over the top was begun. The esterification product collecting at the bottom of the column was continuously withdrawn via a base frit made of glass (pore size 3) and weighed out every second hour:

TABLE 2

| | |
|---|---|
| Operating time | Esterification product |

| h | g | g/h |
|---|---|---|
| 2 | 328.71 | 164.4 |
| 2 | 597.24 | 296.8 |
| 2 | 743.75 | 371.9 |
| 6 | 1669.70 | — |

The HCl gas escaping at the top was conducted through a high-efficiency condenser and freed of entrained phosphorus trichloride, which was recirculated again into the column. The obtained product is of high purity which is reflected in a mono-/diester ratio of 18:1 and the absence of triester. The space-time yield of approx. 0.37 kg/h and reaction space can be further increased.

### 2^{nd} Step (Cyclisation):

Before the start of cyclisation, a large part of the phosphorus trichloride was removed from the esterification mixture with the help of a helical evaporator.

### EXAMPLE 8

The esterification mixture from example 4 is placed in a drip funnel and dripped into a helical evaporator which is temperature-controlled at 155° C. according to Trefzer. The drip rate was 4 ml/min and the average dwell time 10 s. The collected concentrate had a PCl₃ residual content of 14% by weight (see Table 3).

### EXAMPLE 9

The esterification mixture from comparative example 1 was treated analogously to example 8 (see Table 3).

TABLE 3

| | | | PCl₃ residual |
|---|---|---|---|
| Example | Ratio ME/DE | Ratio ME/TE | content/% by wt |
| 8 | 13:1 | No triester | 14.0 |
| | | formation | |
| 9 | 4:1 | 6:1 | 13.8 |

ME = monoester, DE = diester, TE = triester

### EXAMPLE 10

### Comparative Example

0.4 g (2.9 mmol) water-free zinc chloride was added to 47.4 g esterification product, which was obtained analogously to example 9, in a sulphonation flask with agitator, thermometer and drip funnel with an attached bulb condenser under a nitrogen atmosphere and heated to reflux temperature. After reaching reflux temperature, the tap of the drip funnel was adjusted such that, by phosphorus trichloride reflux, a constant reaction temperature of 170° C. was maintained. The HCl gas formed during the cyclisation was conducted over the top with the help of a continuous nitrogen flow into a neutralising solution. The course of the reaction was monitored by gas chromatography and by back titration of the neutralising solution. The reaction was ended after 180 minutes and the HCl evolution ceased. The tap of the drip funnel was closed and the phosphorus trichloride still present in excess was distilled off before the reaction mixture was cooled and analysed by gas chromatography. The product was orange and had a content of DOPCl of 88.2%.

### EXAMPLE 11

0.4 g (2.9 mmol) water-free zinc chloride was added to 47.4 g esterification product, which was obtained analogously to example 8, in a sulphonation flask with agitator, thermometer and drip funnel with an attached bulb condenser under a nitrogen atmosphere and heated to reflux temperature. After reaching reflux temperature, the tap of the drip funnel was adjusted such that, by phosphorus trichloride reflux, a constant reaction temperature of 170° C. was maintained. The HCl gas formed during the cyclisation was conducted over the top with the help of a continuous nitrogen flow into a neutralising solution. The course of the reaction was monitored by gas chromatography and by back titration of the neutralising solution. The reaction was ended after 120 minutes and the HCl evolution ceased. The tap of the drip funnel was closed and the phosphorus trichloride still present in excess was distilled off before the reaction mixture was cooled and analysed by gas chromatography. The product was light yellowish and had a content of DOPCl of 98.2%.

### EXAMPLE 12

0.4 g (2.9 mmol) water-free zinc chloride was added to 47.4 g esterification product, which was obtained analogously to example 8, in a sulphonation flask with agitator, thermometer and drip funnel with an attached bulb condenser under a nitrogen atmosphere and heated to reflux temperature. After reaching reflux temperature, the tap of the drip funnel was adjusted such that, by phosphorus trichloride reflux, a constant reaction temperature of 155° C. was maintained. The HCl gas formed during the cyclisation was conducted over the top with the help of a continuous nitrogen flow into a neutralising solution. The course of the reaction was monitored by gas chromatography and by back titration of the neutralising solution. The reaction was ended after 140 minutes and the HCl evolution ceased. The tap of the drip funnel was closed and the phosphorus trichloride still present in excess was distilled off before the reaction mixture was cooled and analysed by gas chromatography. The product was colourless and had a content of DOPCl of 98.8%.

1. A method for the production of organophosphorus compounds of the general Formula I 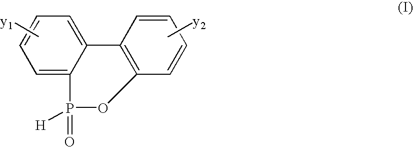
wherein y₁ and y₂, which can be the same or different, can be hydrogen- or halogen atoms, alkyl groups with C₁ to C₁₈, alkoxy groups with C₁ to C₁₈, aryl groups, aryloxy groups, acyl groups, nitro groups or cyano groups, the radicals y₁ and y₂ being able also to form together with the biphenyl ring a phenanthrene ring,
by esterification of phosphorus trihalogenides of the general formula III
PX₃ (III)
wherein X is a halogen atom,
with o-phenylphenols of the general formula IV 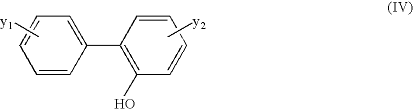
wherein the radicals y₁ and y₂ have the above-mentioned meaning,
in the presence of a catalyst and subsequent hydrolysis, wherein the production method is implemented continuously, at least the following steps, under protective gas, being undergone in succession:
Step 1 esterification of the o-phenylphenol of the general formula IV with an excess of PX₃ of the general formula (III) in the presence of at least one of a catalyst and a plurality of catalysts
Step 2 cyclization of the product from step 1 with at least one of a catalyst and a plurality of catalysts, and
Step 3 hydrolysis of the product from step 2.

2. The method according to claim 1 wherein 1.1 to 5 mol PX₃ to one mol of the o-phenylphenol of the general formula IV is used.

3. The method according to claim 1 wherein the cyclization of step 2 is implemented at temperatures ≧140° C.

4. The method according to claim 1 wherein, before step 2 (cyclization), at least one of the following steps is performed: PX₃ for displacing the equilibrium in the direction of the reaction products of step 2 is added; and the hydrogen halide is removed.

5. The method according to claim 2 wherein at least one of the excess PX₃ and at least one of the not completely converted educts from step 1 and step 2 are separated and recirculated into at least one of step 1 and step 2.

6. The method according to claim 5 wherein the separation is effected by means of distillation.

7. The method according to claim 1 wherein the reaction product of step 2 is held in the melt and transferred into step 3 in the molten state.

8. The method according to claim 7 wherein, during the hydrolysis (step 3), enough water is used such that a two-phase mixture is formed, the lower phase containing the molten product and the upper phase containing the separated hydrogen halide (HX).

9. The method according to claim 1 wherein the hydrolysis is implemented in the molten state at temperatures of 80° C. to 100° C. and atmospheric pressure.

10. The method according to claim 1 wherein the hydrolysis is implemented under a pressure of 3 to 10 bar.

11. The method according to claim 1 wherein the hydrolysis is implemented in a temperature range of 130° C. to 180° C.

12. The method according to claim 1 wherein, during the hydrolysis, an inert aromatic solvent is added.

13. The method according to claim 1 wherein, after the hydrolysis, discharge of the product and drying are effected.

14. The method according to claim 1 wherein non-converted catalyst is recirculated into at least one of step 1 and step 2.

15. The method according to claim 1 wherein the organic phosphorus compound of the general formula I is purified.

16. The method according to claim 15 wherein the purification comprises recrystallization.

17. The method according to claim 1 wherein y_{1, 2} in the general formula I is hydrogen.

18. The method according to claim 1 wherein the at least one catalyst for step 1 is selected from the group consisting of ionic liquids and ion exchangers.

19. The method according to claim 1 wherein the at least one catalyst for step 2 is selected from the group consisting of Lewis acids.

20. The method according to claim 18 wherein the catalyst for step 1, relative to 1 mol of the o-phenylphenol according to Formula I, is used in a quantity of 0.01 to 0.06 mol or 3 to 60% by weight relative to the o-phenylphenol.

21. The method according to claim 19 wherein the catalyst for step 2, relative to 1 mol of the o-phenylphenol according to Formula I, is used in a quantity of 0.01 to 0.06 mol, the catalyst always being present in a quantity of at least 0.01 mol relative to 1 mol of the o-phenylphenol.

22. (canceled)

23. A method of making a flame retardant comprising producing organophosphorus compounds of the general Formula I 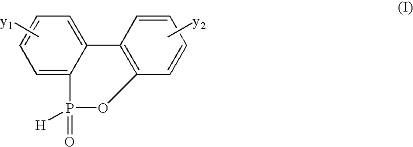
wherein y₁ and y₂, which can be the same or different, can be hydrogen- or halogen atoms, alkyl groups with C₁ to C₁₈, alkoxy groups with C₁ to C₁₈, aryl groups, aryloxy groups, acyl groups, nitro groups or cyano groups, the radicals y₁ and y₂ being able also to form together with the biphenyl ring a phenanthrene ring,
by esterification of phosphorus trihalogenides of the general formula III
PX₃ (III)
wherein X is a halogen atom,
with o-phenylphenols of the general formula IV 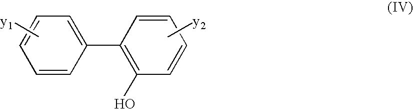
wherein the radicals y₁ and y₂ have the above-mentioned meaning,
in the presence of a catalyst and subsequent hydrolysis, wherein the production method is implemented continuously, at least the following steps, under protective gas, being undergone in succession:
Step 1 esterification of the o-phenylphenol of the general formula IV with an excess of PX₃ of the general formula (III) in the presence of at least one of a catalyst and a plurality of catalysts
Step 2 cyclization of the product from step 1 with at least one of a catalyst and a plurality of catalysts, and
Step 3 hydrolysis of the product from step 2.

24. A method of making epoxy resins comprising producing organophosphorus compounds of the general Formula I 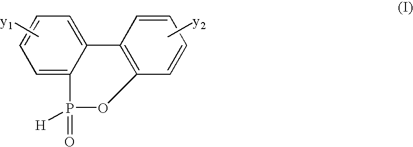
wherein y₁ and y₂, which can be the same or different, can be hydrogen- or halogen atoms, alkyl groups with C₁ to C₁₈, alkoxy groups with C₁ to C₁₈, aryl groups, aryloxy groups, acyl groups, nitro groups or cyano groups, the radicals y₁ and y₂ being able also to form together with the biphenyl ring a phenanthrene ring,
by esterification of phosphorus trihalogenides of the general formula III
PX₃ (III)
wherein X is a halogen atom,
with o-phenylphenols of the general formula IV 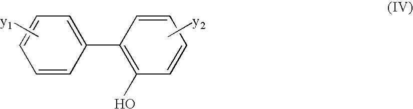
wherein the radicals y₁ and y₂ have the above-mentioned meaning,
in the presence of a catalyst and subsequent hydrolysis, wherein the production method is implemented continuously, at least the following steps, under protective gas, being undergone in succession:
Step 1 esterification of the o-phenylphenol of the general formula IV with an excess of PX₃ of the general formula (III) in the presence of at least one of a catalyst or and a plurality of catalysts
Step 2 cyclization of the product from step 1 with at least one of a catalyst and a plurality of catalysts, and
Step 3 hydrolysis of the product from step 2.
